(19) United States
(12) Patent Application Publication
(10) Pub. No.: US 2018/0175602 A1
(43) Pub. Date: Jun. 21, 2018

(54) Underground Cable Transmissions

(71) Applicant: Christopher John Templeton, Nambour (AU)

(72) Inventor: Christopher John Templeton, Nambour (AU)

(21) Appl. No.: 15/127,756

(22) PCT Filed: Mar. 20, 2015
(86) PCT No.: PCT/AU2015/000158

§ 371 Date: Sep. 20, 2016

(30) Foreign Application Priority Data
Mar. 21, 2014 (AU) 2014900985
Sep. 22, 2014 (AU) 2014101170

(51) Int. Cl. H02G 9/02; H02G 1/06; C09K 17/04

(52) U.S. Cl. CPC H02G 9/02; C09K 17/04; H02G 1/06

(57) ABSTRACT

A manufactured thermally conductive granular backfill product compacted in a trench around an underground electrical transmission cable, the manufactured granular backfill product including a mixture of a granular base material having an R value which is higher than 1.2 when compacted, with a sufficient amount of an additive of a granular iron compound having an R valve which is less than 1.2 when compacted, so as to provide a manufactured thermally conductive granular backfill product having an R value of 1.2 or lower when compacted.

### TECHNICAL FIELD

This invention relates to methods of and materials for improving the performance of underground cable transmission installations.

### BACKGROUND

Transmission cables for electrical power transmission and information transmission are increasingly buried underground to provide improved security compared to overhead cable installations which are exposed and thus easily damaged, for safety reasons and for aesthetic reasons. One of the main considerations when choosing between an underground and an overhead cable installation is the upfront cost and the ease of access should the installation be damaged such as by floods or earthquakes. However underground cable installations, in spite of their upfront costs, are widely used together with overhead cables in many power and communication transmission lines which often extend for hundreds of kilometres between a source and consumers.

Transmission cable networks and particularly power transmission networks start with a finite power source and any losses in a distribution network are costly in terms of efficient use of power generated and the materials consumed in the process of power generation. The initial investment in the generating source and the infrastructure associated with the network are also major considerations when designing a network.

All transmission types have efficiency losses some of which are caused by the generation of heat produced by the transmission. Such heat losses must be dissipated quickly if designed efficiency levels are to be maintained. While air has a very poor capacity for dissipating heat it is utilised very successfully in overhead cable installations for dissipating heat produced in the transmission process. However the design of overhead cables is significantly different to the design of underground cables where the presence of air in the backfill is undesirable. Also the width of any trench containing transmission lines is normally much less than the overall width of the spaced overhead transmission wires and thus much more efficient heat conductive backfill must be used for underground installations and the thermal resistivity of backfill utilised must be significantly lower than the thermal resistivity of air. Alternatively, more expensive cabling must be used.

A thermal resistivity which is significantly reduced beyond that of the native soil is more difficult to achieve in dry areas where the lack of moisture renders the surrounding ground less heat conductive than moist soils and at present, in many instances, it is very difficult to provide consistent natural backfill material having appropriate thermal resistance in a dry state to enable long underground power cables to perform economically.

Authorities responsible for underground cable installations provide codes specifying minimum requirements for transmission lines and for underground power cable installations. The Australian codes specify, inter alia, the depth of the cable installation and a thermal resistivity value, the R value, for the compacted backfill surrounding underground power cable or cables. In Australia, the R value for compacted material around the cable is typically specified as being a maximum of 1.2 metre centigrade/watt. As is common practice, the R value alone without the aforementioned units will be used in the following description.

Transmission line design for AC transmission is a compromise of competing factors such as costs and factors which cause losses such as resistance, inductance, capacitance as well as insulation between the phases and heat dissipation which is a significant limiting factor in transmission line operation as resistive heating, which is a function of the current flowing through the line, must be adequately dissipated from the trench into the native soil to prevent excessive heat build-up leading to inefficiencies and or failure.

Power capability is proportional to voltage squared, therefore very high voltages are used to transmit power over long distances. However as resistivity increases linearly with temperature and predictability of performance is essential, the capability of an underground transmission line is based on installations being made in accordance with a code. In Australia the code AS3008 (2009) “Electrical Installations—selection of cables—Cables for Alternating Voltages up to and including 0.6/1KVA—Typical Australian Installation Conditions” which also specifies an R value of 1.2 for the immediate backfill surrounding the buried cables, as this is considered adequate for maintaining acceptable temperature levels and thus acceptable power losses.

To achieve the necessary performance of underground cables surrounded by compacted backfill with a maximum R value of 1.2, mining or quarry sites which are likely to produce suitable mined material must be identified and operated to supply the backfill material whether it be for a local installation or a remote installation. As the material is naturally occurring, it may contain organic matter or other detrimental impurities in its extracted form and there will be natural variations in the quality of the material in terms of its R value and consequent variations in the performance along the length of underground cable placed with such backfill. This may lead to unpredictable losses in the efficiency of operation of the installation.

Optical fibre cables utilised for information transmission also produce heat which must be dissipated for efficient operation of the optical cables.

This invention in one aspect aims to provide a manufactured backfill product which may be constituted from readily available materials for surrounding buried transmission cables and which will at least conform to specified requirements such as having an R value equal to or less than 1.2 cm/w when compacted, or more preferably conform within a designated range of the R value so that variations in efficiency along the length of the buried cables may be reduced. Other aims and advantages of this invention will hereinafter become apparent.

This invention in another aspect aims to provide a manufactured backfill material which may be constituted from readily available materials for surrounding buried transmission cables and which will have an R value which is significantly less than 1.2 whereby the power or information transmitted through buried cables may be increased beyond that which is currently achieved in underground cables buried with surrounding fill having an R value up to 1.2.

This invention in a further aspect aims to provide a method of economically manufacturing backfill material having a predictable R value. In yet a further aspect, this invention aims to provide a method of lowering the thermal resistivity of soils and dry soils in particular or of mined granular material.

This invention also aims to provide an enhanced method of power or information transmission through buried cables. Other aims and advantages of this invention will hereinafter become apparent.

### SUMMARY OF INVENTION

With the foregoing in view, this invention in one aspect resides broadly in a manufactured thermally conductive granular backfill product compacted in a trench around an underground electrical transmission cable, the manufactured granular backfill product including a mixture of granular base material having an R value which is higher than 1.2 when compacted with sufficient additive of granular iron compound having an R valve which is less than 1.2 when compacted so as to provide a manufactured thermally conductive granular backfill product having an R value of 1.2 or lower when compacted.

In another aspect, the invention resides broadly in a manufactured thermally conductive granular backfill product compacted in a trench around an underground electrical transmission cable, the manufactured granular backfill product including a mixture of granular base material having an R value which is higher than 1.2 when compacted, with sufficient additive of granular iron compound having an R valve which is less than 1.2 when compacted, so as to provide a manufactured thermally conductive granular backfill product having an R value of 1.2 or lower when compacted.

Preferably both the base material and the additive materials are graded mixtures having both fine, coarse and intermediate size particles and a maximum particle dimension of 6 mm whereby, in use, the manufactured thermally conductive backfill product can be compacted to remove most of the entrapped air from the manufactured thermally conductive backfill product. The base material preferably contains silt and sand such as silty sand or clayey sand or mixtures thereof. Other additives may be added to the admixture if desired such as salt which may be added to some metal compounds to reduce their thermal resistivity.

In a another aspect, this invention resides broadly in a method of conducting electricity through an underground cable, the method including encompassing the underground cable in manufactured backfill product as defined above. In a preferred form the method includes lowering the thermal resistivity to such extent that significant increases may be achieved in the power transmitted through a power cable. For example a backfill material containing mostly particulate metal compounds would substantially reduce the thermal conductivity of backfill surrounding power transmission lines enabling significant power increases to be transmitted through the buried transmission line without excessive heat build-up. Alternatively smaller conductors may be utilised to transmit the same power.

In a further aspect, this invention resides broadly in a manufactured backfill product having an R value less than 1.2 and which includes an admixture of silty sand or clayey sand with an additive of granular iron compound. Preferably the iron compound is selected from wustite, hematite or magnetite, although other metal compounds such as copper, lead, gold or pyrites may be used with admixture percentages appropriate for the other metal compound used.

In a further aspect this invention resides in a method of manufacturing backfill material having a targeted thermal resistance, the method including mixing particulate base material with particulate metal or metal compound having a known thermal resistance and in sufficient quantity so as to achieve the targeted thermal resistance. In a preferred method the base material is mixed with particulate iron compound material such as wustite, haematite and magnetite. This particular selection of metal compounds is preferred as the material is readily available. The manufactured thermally conductive backfill is formed from readily available mined additive material which can be milled to form a well graded particulate mixture which can be readily mixed with silty sand or clayey sand used as the base material to form a relatively homogenous admixture which can be compacted in a trench and surrounding transmission cables using conventional construction machinery so as to reduce air and voids in the backfill.

The maximum dimension of the metal or metal compound has been given above as no greater than 6 mm, as larger particles can damage cabling covers. An admixture according to this invention may advantageously utilise only much smaller particle sizes which facilitate reduction in voids in the admixture and thus provide an increase in the thermal conductivity of the admixture. Of course compaction in accordance with known methods assists in the reduction of voids and may be stipulated to achieve a predicted or experimentally derived R value.

In yet a further aspect this invention resides broadly in a method of forming underground encapsulation of transmission cables in dry areas where thermal conductivity of backfill material is not enhanced by the presence of moisture, the method including mixing a particulate base material and particulate metal or metal compound in a ratio selected to provide the nominated thermal resistance for the backfill material. Preferably the base material is a silty sand or a clayey sand which is mixed with a particulate iron compound to achieve the nominated thermal resistance.

In yet a further aspect, this invention provides a method of lowering the thermal resistivity of soil and dry soil in particular or of mined or excavated granular material, the method including mixing particulate metal or metal compound to the dry soil or mined granular material. In a preferred form of the invention mined particulate metal compound is added to achieve a lower thermal resistance and preferably a mined iron compound is added.

In a further aspect this invention resides broadly in a method of transmitting electricity through an underground power cable, the method including:—

excavating a relatively narrow trench along the route of the proposed underground cable;

adding backfill to the base of the trench which may include an upper layer of manufactured backfill having a specified maximum R value;

placing the power cable in the trench;

surrounding the power cable with manufactured backfill having a specified maximum R value;

compacting the backfill so as to significantly reduce voids in the manufactured backfill surrounding the cable, wherein the manufactured backfill is manufactured in accordance with an aspect of this invention whereby heat conduction away from the buried power cable throughout its length may be maintained at a level which prevents overheating of the cable in normal use.

The manufactured thermally conductive backfill product will enable substantially consistent heat dissipation from the cable to be achieved throughout the length of the cable to prevent or at least reduce localised overheating. For this purpose, the manufactured backfill material may be manufactured to specified relatively close maximum and minimum R values so as to achieve a substantially constant heat dissipation from the underground cable throughout its length.

A reference to base material in this specification is not a reference to a dominant material by volume or weight in an admixture made according to this invention, it simply refers to a material which may be mined on site or off site, is suitable for backfill and has an R value which is higher than 1.2.

In order that this invention may be more readily understood and put into practical effect reference will now be made to the following examples which illustrate preferred embodiments of the invention.

In a first test, magnetite was added to a clayey sand in a range of concentrations, oven dried and tested for field dry density, laboratory tested dry density, maximum dry density, optimum moisture content, thermal conductivity (and hence thermal resistivity). A standard deviation was determined from the number of test samples in each range, the results being set forth in Tables 1 and 2 below.

TABLE 1

| | Clayey | Clayey | Clayey | Clayey | Clayey | Clayey |
|---|---|---|---|---|---|---|
| Soil | Sand | Sand 10% | Sand 20% | Sand 30% | Sand 40% | Sand 50% |
| Descr'n | Control | Magnetite | Magnetite | Magnetite | Magnetite | Magnetite |
| Placement | Oven | Oven | Oven | Oven | Oven | Oven |
| Moisture | Dried | Dried | Dried | Dried | Dried | Dried |
| Content (%) | | | | | | |
| Field Dry | n/a | n/a | n/a | n/a | n/a | n/a |
| Density | | | | | | |
| (t/m³) | | | | | | |
| Laboratory | 1.64 | 1.70 | 1.74 | 1.79 | 1.86 | 1.92 |
| Tested Dry | | | | | | |
| Density | | | | | | |
| (t/m³) | | | | | | |
| Maximum | 1.64 | 1.70 | 1.74 | 1.79 | 1.86 | 1.92 |
| Dry Density | | | | | | |
| (t/m³) | | | | | | |
| Optimum | 10.9 | 10.5 | 10.1 | 9.9 | 9.4 | 9.3 |
| Moisture | | | | | | |
| Content (%) | | | | | | |
| Thermal | 0.75 | 1.00 | 1.26 | 1.45 | 1.69 | 1.89 |
| Conductivity | | | | | | |
| (W/mK) | | | | | | |
| Thermal | 1.3 | 1.00 | 0.79 | 1.69 | 1.59 | 1.53 |
| Resistivity | | | | | | |
| (mK/W) | | | | | | |
| Standard | 0.05 | 0.08 | 0.05 | 0.04 | 0.05 | 0.06 |
| Deviation | | | | | | |

TABLE 2

| | Clayey | Clayey | Clayey | Clayey | Clayey |
|---|---|---|---|---|---|
| | Sand | Sand | Sand | Sand | Sand |
| Soil | 60% | 70% | 80% | 90% | 100% |
| Description | Magnetite | Magnetite | Magnetite | Magnetite | Magnetite |
| Placement | Oven | Oven | Oven | Oven | Oven |
| Moisture | Dried | Dried | Dried | Dried | Dried |
| Content (%) | | | | | |
| Field Dry | n/a | n/a | n/a | n/a | n/a |
| Density | | | | | |
| (t/m³) | | | | | |
| Laboratory | 1.92 | 1.94 | 1.98 | 2.06 | 2.15 |
| Tested Dry | | | | | |
| Density | | | | | |
| (t/m³) | | | | | |
| Maximum | 1.92 | 1.94 | 1.98 | 2.06 | 2.15 |
| Dry Density | | | | | |
| (t/m³) | | | | | |
| Optimum | 9.1 | 9.0 | 8.5 | 8.0 | 7.4 |
| Moisture | | | | | |
| Content (%) | | | | | |
| Thermal | 1.89 | 1.99 | 2.11 | 2.37 | 2.55 |
| Conductivity | | | | | |
| (W/mK) | | | | | |
| Thermal | 0.53 | 0.50 | 0.47 | 0.42 | 0.39 |
| Resistivity | | | | | |
| (mK/W) | | | | | |
| Standard | 0.03 | 0.07 | 0.06 | 0.06 | 0.09 |
| Deviation | | | | | |

In a second test, hematite was added to a clayey sand in a range of concentrations, oven dried and tested for field dry density, laboratory tested dry density, maximum dry density, optimum moisture content, thermal conductivity (and hence thermal resistivity). A standard deviation was determined from the number of test samples in each range, the results being set forth in Tables 3 and 4 below.

TABLE 3

| | Clayey | Clayey | Clayey | Clayey | Clayey |
|---|---|---|---|---|---|
| | Sand | Sand | Sand | Sand | Sand |
| Soil | 10% | 20% | 30% | 40% | 50% |
| Description | Hematite | Hematite | Hematite | Hematite | Hematite |
| Placement | Oven | Oven | Oven | Oven | Oven |
| Moisture | Dried | Dried | Dried | Dried | Dried |
| Content (%) | | | | | |
| Field Dry | n/a | n/a | n/a | n/a | n/a |
| Density | | | | | |
| (t/m³) | | | | | |
| Laboratory | 1.67 | 1.7 | 1.72 | 1.79 | 1.83 |
| Tested Dry | | | | | |
| Density | | | | | |
| (t/m³) | | | | | |
| Maximum | 1.67 | 1.7 | 1.72 | 1.79 | 1.83 |
| Dry Density | | | | | |
| (t/m³) | | | | | |
| Optimum | 11.0 | 10.8 | 10.8 | 10.6 | 10.5 |
| Moisture | | | | | |
| Content (%) | | | | | |
| Thermal | 0.81 | 0.95 | 1.07 | 1.15 | 1.29 |
| Conductivity | | | | | |
| (W/mK) | | | | | |
| Thermal | 1.23 | 1.05 | 0.93 | 1.87 | 0.78 |
| Resistivity | | | | | |
| (mK/W) | | | | | |
| Standard | 0.05 | 0.05 | 0.07 | 0.08 | 0.06 |
| Deviation | | | | | |

TABLE 4

| | Clayey | Clayey | Clayey | Clayey | Clayey |
|---|---|---|---|---|---|
| | Sand | Sand | Sand | Sand | Sand |
| Soil | 60% | 70% | 80% | 90% | 100% |
| Description | Hematite | Hematite | Hematite | Hematite | Hematite |
| Placement | Oven | Oven | Oven | Oven | Oven |
| Moisture | Dried | Dried | Dried | Dried | Dried |
| Content (%) | | | | | |
| Field Dry | n/a | n/a | n/a | n/a | n/a |
| Density | | | | | |
| (t/m³) | | | | | |
| Laboratory | 1.86 | 1.99 | 2.09 | 2.11 | 2.20 |
| Tested Dry | | | | | |
| Density | | | | | |
| (t/m³) | | | | | |
| Maximum | 1.86 | 1.99 | 2.09 | 2.11 | 2.20 |
| Dry Density | | | | | |
| (t/m³) | | | | | |
| Optimum | 10.1 | 10.0 | 9.9 | 9.9 | 9.5 |
| Moisture | | | | | |
| Content (%) | | | | | |
| Thermal | 1.48 | 1.37 | 1.54 | 1.89 | 2.03 |
| Conductivity | | | | | |
| (W/mK) | | | | | |
| Thermal | 0.68 | 0.73 | 0.65 | 0.53 | 0.49 |
| Resistivity | | | | | |
| (mK/W) | | | | | |
| Standard | 0.07 | 0.06 | 0.06 | 0.07 | 0.04 |
| Deviation | | | | | |

In a third test, various dry materials were added to a dry silty sand having or being adjusted to about 10% pyrites. The dry materials were added at particular concentrations and tested for placement moisture content, field dry density, laboratory tested dry density, maximum dry density, optimum moisture content, thermal conductivity (and hence thermal resistivity). A standard deviation was determined from the number of test samples in each range, the results being set forth in Tables 5 and 6 below.

TABLE 5

| | Silty Sand | Silty Sand | Silty Sand | Silty Sand | Silty Sand |
|---|---|---|---|---|---|
| | about 10% | about 10% | about 10% | about 10% | about 10% |
| Soil | Pyrites | Pyrites 2% | Pyrites 4% | Pyrites 6% | Pyrites 8% |
| Description | No NaCl | NaCl | NaCl | NaCl | NaCl |
| Placement | 0.0 | 0.0 | 0.0 | 0.0 | 0.0 |
| Moisture | | | | | |
| Content (%) | | | | | |
| Field Dry | n/a | n/a | n/a | n/a | n/a |
| Density | | | | | |
| (t/m³) | | | | | |
| Laboratory | 1.64 | 1.67 | 1.65 | 1.62 | 1.61 |
| Tested Dry | | | | | |
| Density | | | | | |
| (t/m³) | | | | | |
| Maximum | 1.64 | 1.67 | 1.65 | 1.62 | 1.61 |
| Dry Density | | | | | |
| (t/m³) | | | | | |
| Optimum | 12.0 | 12.0 | 12.0 | 12.0 | 12.0 |
| Moisture | | | | | |
| Content (%) | | | | | |
| Thermal | 0.68 | 0.86 | 1.02 | 0.99 | 0.92 |
| Conductivity | | | | | |
| (W/mK) | | | | | |
| Thermal | 1.47 | 1.16 | 0.98 | 1.01 | 1.09 |
| Resistivity | | | | | |
| (mK/W) | | | | | |
| Standard | 0.03 | 0.05 | 0.3 | 0.4 | 0.05 |
| Deviation | | | | | |

TABLE 6

| | | | Silty Sand | | |
|---|---|---|---|---|---|
| | | | about 10% | | |
| | Silty Sand | Silty Sand | Pyrites 2% | Silty Sand | Silty Sand |
| | about 10% | about 10% | Alu- | about 10% | about 10% |
| Soil | Pyrites | Pyrites 3% | minium | Pyrites 2% | Pyrites 2% |
| Description | no NaCl | Dolomite | Sulphate | NaCl | Magnetite |
| Placement | 0.0 | 0.0 | 0.0 | 0.0 | 0.0 |
| Moisture | | | | | |
| Content (%) | | | | | |
| Field Dry | n/a | n/a | n/a | n/a | n/a |
| Density | | | | | |
| (t/m³) | | | | | |
| Laboratory | 1.64 | 1.67 | 1.63 | 1.67 | 1.70 |
| Tested Dry | | | | | |
| Density | | | | | |
| (t/m³) | | | | | |
| Maximum | 1.64 | 1.67 | 1.63 | 1.67 | 1.70 |
| Dry Density | | | | | |
| (t/m³) | | | | | |
| Optimum | 12.0 | 12.0 | 12.0 | 12.0 | 12.0 |
| Moisture | | | | | |
| Content (%) | | | | | |
| Thermal | 0.68 | 1.53 | 1.66 | 10.5 | 0.78 |
| Conductivity | | | | | |
| (W/mK) | | | | | |
| Thermal | 1.47 | 1.89 | 1.51 | 0.95 | 1.28 |
| Resistivity | | | | | |
| (mK/W) | | | | | |
| Standard | 0.03 | 0.05 | 0.06 | 0.03 | 0.03 |
| Deviation | | | | | |

In a fourth test, various dry materials were added to a dry silty sand having or being adjusted to about 10% pyrites. The dry materials were added at particular concentrations and tested for placement moisture content, field dry density, laboratory tested dry density, maximum dry density, optimum moisture content, thermal conductivity (and hence thermal resistivity). A standard deviation was determined from the number of test samples in each range, the results being set forth in Tables 5 and 6 below.

TABLE 7

| | | Silty Sand | Silty Sand | Silty Sand | Silty Sand |
|---|---|---|---|---|---|
| | Silty Sand | about 10% | about 10% | about 10% | about 10% |
| | about 10% | Pyrites 2% | Pyrites 4% | Pyrites 2% | Pyrites 4% |
| Soil | Pyrites | Hydrated | Hydrated | Calcium | Calcium |
| Description | No NaCl | Lime | Lime | Carbonate | Carbonate |
| Placement | 0.0 | 0.0 | 0.0 | 0.0 | 0.0 |
| Moisture | | | | | |
| Content (%) | | | | | |
| Field Dry | n/a | n/a | n/a | n/a | n/a |
| Density | | | | | |
| (t/m³) | | | | | |
| Laboratory | 1.64 | 1.53 | 1.47 | 1.61 | 1.58 |
| Tested Dry | | | | | |
| Density | | | | | |
| (t/m³) | | | | | |
| Maximum | 1.64 | 1.53 | 1.47 | 1.61 | 1.58 |
| Dry Density | | | | | |
| (t/m³) | | | | | |
| Optimum | 12.0 | 12.0 | 12.0 | 12.0 | 12.0 |
| Moisture | | | | | |
| Content (%) | | | | | |
| Thermal | 0.68 | 0.48 | 0.39 | 0.48 | 0.36 |
| Conductivity | | | | | |
| (W/mK) | | | | | |
| Thermal | 1.47 | 2.08 | 2.56 | 2.08 | 2.78 |
| Resistivity | | | | | |
| (mK/W) | | | | | |
| Standard | 0.03 | 0.05 | 0.04 | 0.03 | 0.03 |
| Deviation | | | | | |

TABLE 8

| | | | Silty Sand | | |
|---|---|---|---|---|---|
| | | Silty | about 10% | | |
| | Silty Sand | Sand | Pyrites 2% | Silty Sand | Silty Sand |
| | about 10% | about 10% | Alu- | about 10% | about 10% |
| Soil | Pyrites | Pyrites 3% | minium | Pyrites 2% | Pyrites 2% |
| Description | no NaCl | Dolomite | Sulphate | NaCl | Magnetite |
| Placement | 0.0 | 0.0 | 0.0 | 0.0 | 0.0 |
| Moisture | | | | | |
| Content (%) | | | | | |
| Field Dry | n/a | n/a | n/a | n/a | n/a |
| Density | | | | | |
| (t/m³) | | | | | |
| Laboratory | 1.64 | 1.79 | 1.68 | 1.61 | 1.70 |
| Tested Dry | | | | | |
| Density | | | | | |
| (t/m³) | | | | | |
| Maximum | 1.64 | 1.79 | 1.68 | 1.61 | 1.70 |
| Dry Density | | | | | |
| (t/m³) | | | | | |
| Optimum | 12.0 | 12.0 | 12.0 | 12.0 | 12.0 |
| Moisture | | | | | |
| Content (%) | | | | | |
| Thermal | 0.68 | 0.40 | 0.90 | 1.00 | 0.96 |
| Conductivity | | | | | |
| (W/mK) | | | | | |
| Thermal | 1.47 | 2.05 | 1.11 | 1.00 | 1.04 |
| Resistivity | | | | | |
| (mK/W) | | | | | |
| Standard | 0.03 | 0.04 | 0.04 | 0.03 | 0.03 |
| Deviation | | | | | |

In a typical installation, an underground electrical cable may be designed for efficient operation when installed in a trench surrounded by backfill having a thermal resistivity R value in the range of 0.7 to 0.9.

According to this invention the backfill material throughout the length of the underground cable may be provided by mining some or all of the constituents for manufacturing the backfill on site or adjacent the site or by utilising a base material and an additive of granular iron compound of known qualities which may be stockpiled ready for use.

Typically the invention would be performed by determining the R value of the base material proposed to be used as backfill to surround the cable so that the amount of additive iron compound in granular form required to modify the R value of that base material to meet the specified range may be determined. The iron compound additive may be bulk additive of known quality maintained in storage or the additive may, if available, be mined on site, or adjacent the site and if economics or other considerations determine that local mining and crushing provides a satisfactory source for the iron compound.

For example, the base material may be dried and tested to have a compacted R value of 1.4 and the mined iron compound additive, which may be for example magnetite, may have an R value of 0.6 when compacted. These materials may be mixed together and compacted to provide samples with varying percentage mixtures which may be tested to determine the percentage or range of percentages of additive needed to be mixed with the base material to achieve the desired R value in the compacted form of the manufactured product specified for the installation.

Once this is established the backfill with the additive may be manufactured on site so that the R value design criteria may be met in an economically feasible or politically acceptable manner. Where there are variations in the quality of the base material along the length of the cable, as may be shown by constant testing at selected intervals, for example, the percentage of the iron compound additive can be varied as necessary to achieve a suitably consistent R value backfill throughout the length of the underground cable installation.

The manufactured backfill product may be utilised as backfill extending to a nominated extent about the buried cable, or the trench in which the cable is buried may be substantially filled with the manufactured backfill material. Using substantially all manufactured backfill material or backfill material to a specified depth provides an opportunity to narrow the trench which is typically formed to support the cable and provide additional cost savings in the underground installation without detrimental effects on the performance of the buried power cable. Cost savings may also be achieved by de-rating the cable used to transmit the same power. This invention could be performed by manufacturing the backfill product from stockpiles of base material and particulate iron compound each having known or confirmed R values and manufactured thermally conductive backfill product having R values obtained from test results or otherwise predicted and transporting either the manufactured product or product components to the worksite either ready for use or ready for mixing at the site prior to use.

In the second circumstance, the invention could be performed by manufacturing the backfill from stockpiles of base material and particulate metal or metal compound each having known or confirmed R values and admixture R values obtained from test results or otherwise predicted and transporting either the admixture or the admixture components to the worksite either ready for use or ready for mixing at the site prior to use.

With sufficient testing it is believed that tables can be established which will permit ready identification of the amount of metal or metal compound additive needed to be mixed with a base material having a known R value to achieve an admixture of base material metal or metal compound additive to achieve the desired R value.

In some installations important considerations other than the thermal resistivity may be specified for a particular site, which may be for example the strength of the compacted backfill. According to this invention it may also be possible to provide an admixture having the desired qualities by utilising selected graded base materials and metal or metal compound additives formed of particle sizes meeting the desired result in the installation.

Preliminary tests show that addition of granular iron compounds to backfill does reduce its thermal resistivity in a manner which should enable prediction of the thermal conductivity of an admixture of base material and an iron compound additive. The manufactured backfill product may be manufactured to specified relatively close maximum and minimum R values so as to achieve, in use, a substantially constant heat dissipation from an underground cable throughout its length.

It will of course be realised that the above has been given only by way of illustrative example of this invention and that all such modifications and variations thereto as would be apparent to persons skilled in the art are deemed to fall within the broad scope and ambit of this invention as is defined by the following claims.

What is claimed is:

1. A manufactured thermally conductive granular backfill product compacted in a trench around an underground electrical transmission cable, the manufactured granular backfill product including a mixture of a granular base material having an R value higher than 1.2 compacted with an additive of granular iron compound having an R value less than 1.2 compacted to provide the manufactured thermally conductive granular backfill product with an R value of 1.2 or lower when compacted.

2. The manufactured thermally conductive granular backfill material according to claim 1, wherein both the granular base material and the additive of granular iron compound are graded mixtures having both fine, coarse and intermediate size particles and a maximum particle dimension of 6 mm wherein the manufactured thermally conductive backfill product is be compacted to remove entrapped air from the manufactured thermally conductive backfill product.

3. The manufactured thermally conductive granular backfill material according to claim 1, wherein the granular base material comprises silt and sand or mixtures thereof to provide silty sand or clayey sand or any combination thereof.

4. The manufactured thermally conductive granular backfill material according to claim 3, wherein the additive of granular iron compound includes a metal or metal ore and including salt added to reduce thermal resistivity of metal or metal ore.

5. The manufactured thermally conductive granular backfill product according to claim 1, including an underground cable.

6. The manufactured thermally conductive granular backfill product according to claim 1, having an R value less than 1.2 and which includes an admixture of silty sand or clayey sand with the additive of granular iron compound.

7. The manufactured thermally conductive granular backfill product according to claim 6, wherein the additive of granular iron compound is selected from wustite, hematite, magnetite, or the ores of copper, lead, gold or pyrites.

8. A method of manufacturing backfill material having a targeted thermal resistance, the method including mixing a particulate base material with an additive material being a particulate metal or metal compound having a known thermal resistance and in a quantity so as to achieve a targeted thermal resistance.

9. The method according to claim 8, wherein the particulate metal or metal compound includes an iron compound material selected from wustite, hematite and magnetite.

10. The method according to claim 8, including milling the additive material to form a well graded particulate mixture, mixing the additive material with silty sand or clayey sand used as a base material, to form a relatively homogenous admixture.

11. The method according to claim 10, wherein a maximum dimension of the metal or metal compound is 6 mm.

12. The method according to claim 11, wherein an admixture includes particle sizes that reduce voids in the admixture.

13. The method of claim 8, further comprising forming underground encapsulation of transmission cables including mixing the particulate base material and the particulate metal or metal compound in a ratio selected to provide a nominated thermal resistance for the backfill material.

14. The method of claim 13, comprising lowering thermal resistivity of a soil including mixing the particulate metal or metal compound to a dry soil or a mined granular material.

15. A method of transmitting electricity through a power cable to be placed underground, the method including:
excavating a trench along the proposed route of the power cable;
adding backfill to the base of the trench to include an upper layer of manufactured backfill having a specified maximum R value;
placing the power cable in the trench;
surrounding the power cable with manufactured backfill having a specified maximum R value;
compacting the backfill so as to significantly reduce voids in the manufactured backfill surrounding the cable, wherein the manufactured backfill is manufactured in accordance the backfill material according to claim 1, whereby heat conduction away from the buried power cable throughout its length may be maintained at a level which prevents overheating of the cable in normal use.
